(19) United States
(12) Patent Application Publication
(10) Pub. No.: US 2023/0295974 A1
(43) Pub. Date: Sep. 21, 2023

(54) WINDOW REGULATOR AND GUIDE RAIL ATTACHING METHOD

(71) Applicant: Johnan Manufacturing Inc., Nagano (JP)

(72) Inventor: Raku HARADA, Nagano (JP)

(21) Appl. No.: 18/176,235

(22) Filed: Feb. 28, 2023

(30) Foreign Application Priority Data
Mar. 18, 2022 (JP) 2022-044561

(51) Int. Cl. E05F 11/48; E05F 15/689

(52) U.S. Cl. CPC E05F 11/483; E05F 15/689; E05Y 2201/10; E05Y 2201/64; E05Y 2201/654; E05Y 2201/664; E05Y 2201/684; E05Y 2600/458; E05Y 2600/52

(57) ABSTRACT

A window regulator includes a guide rail and a drum housing at an end of the guide rail. The guide rail includes a flat plate portion extending in the ascending/descending direction, and a side plate portion rising from the flat plate portion. The drum housing includes a fitting hole into which the end of the guide rail is inserted and fitted, a first fitting guide wall extending from a first inner surface of the fitting hole toward the near side in an insertion direction so as to protrude from an edge of the fitting hole and guiding the flat plate portion to the fitting hole, and a second fitting guide wall extending from a second inner surface of fitting hole toward the near side in the insertion direction so as to protrude from the edge of the fitting hole and guiding the side plate portion to the fitting hole.

### CROSS-REFERENCE TO RELATED APPLICATIONS

The present patent application claims the priority of Japanese patent application No. 2022/044561 filed on Mar. 18, 2022, and the entire contents of Japanese patent application No. 2022/044561 are hereby incorporated by reference.

### TECHNICAL FIELD

The present invention relates to a window regulator and a guide rail attaching method.

### BACKGROUND ART

Known wire driving-type window regulators include a lower end drive-type window regulator having a drive unit at a lower end of a guide rail (see Patent Literature 1). The window regulator includes a guide rail provided along an ascending/descending direction of a vehicle window glass, wires (cables) to pull the carrier plate, a drum to take up and feed out the wires, and a drum housing provided at a lower end of the guide rail and having a housing space to house the drum. The window regulator is designed such that a fitting hole into which the lower end of the guide rail is fitted is formed on the drum housing, and the guide rail can be attached to the drum housing by inserting and fitting the lower end of the guide rail into the fitting hole.

### CITATION LIST

### Patent Literature

Patent Literature 1: JP 2020/165087A

### SUMMARY OF THE INVENTION

In the window regulator, the guide rail needs to be attached to the drum housing by first visually checking the position of the fitting hole, then aligning the guide rail with the fitting hole, then moving the guide rail toward the fitting hole and inserting it into the fitting hole. Thus, there may be room for improvement in the attachment workability of the guide rail.

It is an object of the invention to provide a window regulator and a guide rail attaching method that allow the attachment workability of the guide rail to be improved.

An aspect of the invention provides a window regulator, comprising:
a guide rail provided along an ascending/descending direction of a window glass of a vehicle;
a carrier plate that supports the window glass and is slidably attached to the guide rail;
a wire to pull the carrier plate;
a rotating drum to take up and feed out the wire by rotating; and
a drum housing being provided at an end of the guide rail and housing the rotating drum,
wherein the guide rail comprises a flat plate portion extending in the ascending/descending direction, and a side plate portion rising from the flat plate portion, and
wherein the drum housing comprises a fitting hole into which the end of the guide rail is inserted and fitted, a first fitting guide wall extending from a first inner surface of the fitting hole toward the near side in an insertion direction so as to protrude from an edge of the fitting hole and guiding the flat plate portion to the fitting hole, and a second fitting guide wall extending from a second inner surface of the fitting hole toward the near side in the insertion direction so as to protrude from the edge of the fitting hole and guiding the side plate portion to the fitting hole.

Another aspect of the invention provides a guide rail attaching method for attaching the guide rail to the drum housing in the window regulator described above, the method comprising:

after bringing the flat plate portion and the side plate portion respectively into contact with the first fitting guide wall and the second fitting guide wall, moving the guide rail toward the fitting hole while keeping the flat plate portion and the side plate portion respectively in sliding contact with the first fitting guide wall and the second fitting guide wall, thereby inserting the guide rail into the fitting hole.

Another aspect of the invention provides a window regulator, comprising:
a guide rail provided along an ascending/descending direction of a window glass of a vehicle;
a carrier plate that supports the window glass and is slidably attached to the guide rail;
a wire to pull the carrier plate; and
a rotating drum to take up and feed out the wire by rotating,
wherein the guide rail comprises a flat plate portion extending in the ascending/descending direction, and a side plate portion rising from the flat plate portion, and
wherein the carrier plate comprises an insertion portion into which the guide rail is inserted, a first insertion guide wall extending from a first inner surface of the insertion portion toward the near side in an insertion direction so as to protrude from an edge of the insertion portion on the near side in the insertion direction and guiding the flat plate portion to the insertion portion, and a second insertion guide wall extending from a second inner surface of the insertion portion toward the near side in the insertion direction so as to protrude from the edge of the insertion portion on the near side in the insertion direction and guiding the side plate portion to the insertion portion.

Another aspect of the invention provides a guide rail attaching method for attaching the guide rail to the carrier plate in the window regulator described above, the method comprising:

after bringing the flat plate portion and the side plate portion respectively into contact with the first insertion guide wall and the second insertion guide wall, moving the guide rail toward the insertion portion while keeping the flat plate portion and the side plate portion respectively in sliding contact with the first insertion guide wall and the second insertion guide wall, thereby inserting the guide rail into the insertion portion.

### Advantageous Effects of Invention

The window regulator and the guide rail attaching method of the invention can improve the attachment workability of the guide rail.

### BRIEF DESCRIPTION OF DRAWINGS

FIG. 1 is a general schematic diagram illustrating a window regulator in an embodiment of the present invention and a vehicle door in which the window regulator is installed.

FIG. 2A is a front view showing the window regulator when a window glass is fully closed.

FIG. 2B is a front view showing the window regulator when the window glass is fully open.

FIG. 2C is a front view showing the window regulator when the window glass is half open.

FIG. 3 is a side view showing the window regulator when the window glass is half open.

FIG. 4A is a cross-sectional view taking along line A-A′ in FIG. 2A and showing a guide rail.

FIG. 4B is a cross-sectional view taking along line B-B′ in FIG. 2C and showing a portion around a carrier plate.

FIG. 4C is a cross-sectional view taking along line C-C′ in FIG. 3 and showing a portion around a fitting hole.

FIG. 5A is a front view showing the carrier plate.

FIG. 5B is a plan view showing the carrier plate.

FIG. 5C is a back view showing the carrier plate.

FIG. 6A is a side view showing the carrier plate.

FIG. 6B is a perspective view showing the carrier plate.

FIG. 7A is a front view showing a drum housing.

FIG. 7B is a plan view showing the drum housing.

FIG. 8A is a side view showing the drum housing.

FIG. 8B is a perspective view showing the drum housing.

FIGS. 9A, 9B, and 9C illustrate a side view and two front views, respectively, of a first guide rail attachment operation wherein the carrier plate is slidingly attached to the guide rail.

FIGS. 10A, 10B, and 10C illustrate a side view and two front views, respectively, of a second guide rail attachment operation wherein the carrier plate is slidingly attached to the drum housing.

FIG. 11A is a front view showing a modification of the drum housing.

FIG. 11B is a plan view showing the modification of the drum housing.

FIG. 11C is a perspective view showing the modification of the drum housing.

FIG. 12A is a cross-sectional view showing the guide rail in the first modification.

FIG. 12B is a cross-sectional view showing a portion around the fitting hole to which the guide rail in the first modification is fitted.

FIG. 12C is a cross-sectional view showing the guide rail in the second modification.

FIG. 12D is a cross-sectional view showing a portion around the fitting hole to which the guide rail in the second modification is fitted.

FIG. 12E is a cross-sectional view showing the guide rail in the third modification.

FIG. 12F is a cross-sectional view showing a portion around the fitting hole to which the guide rail in the third modification is fitted.

### DETAILED DESCRIPTION OF THE INVENTION

A window regulator and a guide rail attaching method in an embodiment of the invention will be described below in reference to the appended drawings. This window regulator is a raising/lowering device that is installed in a vehicle door provided on a vehicle (e.g., an automobile) and raises/lowers a window glass on the vehicle door. Particularly in this wind regulator, a carrier plate and a drum housing have a guide structure to improve the attachment workability of the guide rail. Hereinafter, an ascending/descending direction of the window glass of the vehicle is simply referred to as the ascending/descending direction. In addition, left, right, front, rear, up and down used in the following description are as defined in each drawing. In the present embodiment, it is assumed that the ascending/descending direction coincides with the up-down direction of the window regulator, and a vehicle width direction coincides with a front-rear direction of the window regulator. In addition, a direction orthogonal to the ascending/descending direction and the vehicle width direction is a left-right direction of the window regulator.

### Configuration of the Window Regulator

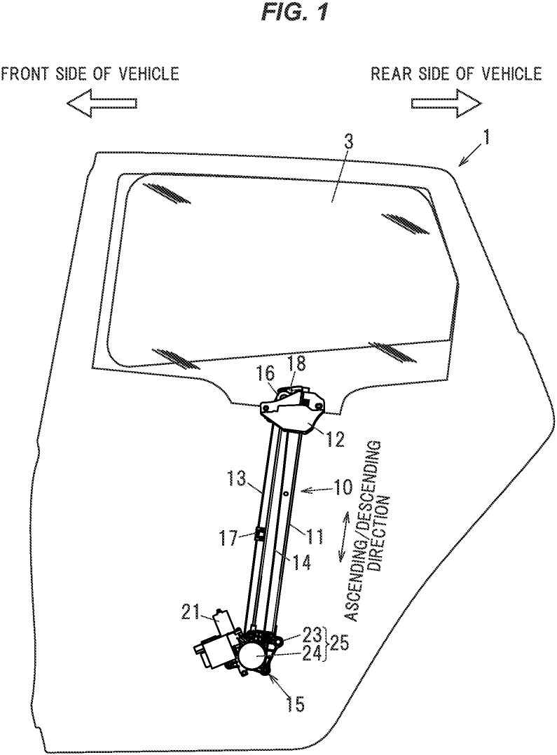

As shown in FIGS. 1 to 3, a window regulator 10 is installed in a vehicle door 1 and includes a guide rail 11 provided along the ascending/descending direction, a carrier plate 12 that supports a window glass 3 and is slidably attached to the guide rail 11, an ascending-side wire 13 and a descending-side wire 14 that pull the carrier plate 12, a drive unit 15 provided at a lower end of the guide rail 11 to drive the ascending-side wire 13 and the descending-side wire 14, a pulley 16 provided at an upper end of the guide rail 11 through a pulley bracket 18 to change the direction of the ascending-side wire 13, and a wire guide 17 provided at substantially the longitudinal center of the guide rail 11 to support the ascending-side wire 13 routed between the pulley 16 and the drive unit 15. That is, this window regulator 10 is a wire driving-type window regulator to raise and lower the carrier plate 12 using the wires 13, 14 and is also a lower end drive-type window regulator having the drive unit 15 arranged at the lower end of the guide rail 11.

The ascending-side wire 13 is attached to the carrier plate 12 at one end, passes through the pulley 16, and is coupled to a rotating drum 22 (described later) of the drive unit 15 at the other end. Meanwhile, the descending-side wire 14 is attached to the carrier plate 12 at one end and is coupled to the rotating drum 22 at the other end.

The drive unit 15 has a motor 21, the cylindrical rotating drum 22 that is rotationally driven by the motor 21 and takes up and feeds out the ascending-side wire 13 and the descending-side wire 14 by rotating, a reducer (not shown) to transfer rotation of the motor 21 to the rotating drum 22, and a housing 25 composed of a drum housing 23, to which the lower end of the guide rail 11 is fitted and which rotatably houses the rotating drum 22, and a motor housing 24 holding the motor 21. The motor housing 24 incorporates the reducer and is fixed to the drum housing 23. The motor housing 24 covers an opening of a drum housing portion 71 of the drum housing 23 (described later) in a state in which an output shaft of the reducer is connected to the rotating drum 22. The details of the drum housing 23 will be described later.

When the motor 21 is rotated in forward, the rotating drum 22 rotates in the forward direction and takes up the ascending-side wire 13 while feeding out the descending-side wire 14. Thus, the carrier plate 12 is pulled by the ascending-side wire 13 and moves upward in the ascending/descending direction. As a result, the window glass 3 attached to the carrier plate 12 ascends. On the other hand, when the motor 21 is rotated in reverse, the rotating drum 22 rotates in the reverse direction and takes up the descending-side wire 14 while feeding out the ascending-side wire 13. Thus, the carrier plate 12 is pulled by the descending-side wire 14 and moves downward in the ascending/descending direction. As a result, the window glass 3 attached to the carrier plate 12 descends. In this manner, the carrier plate 12 and the window glass 3 are raised and lowered along the guide rail 11.

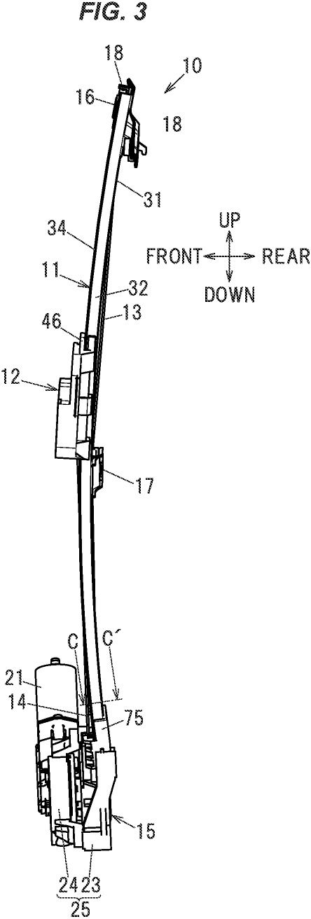

As shown in FIGS. 1 and 3, the guide rail 11 is formed by bending a long metal plate so as to be curved toward the outside of a vehicle cabin at a predetermined curvature, and is arranged so as to tilt to the rear side in a vehicle front-rear direction with respect to the vehicle door 1.

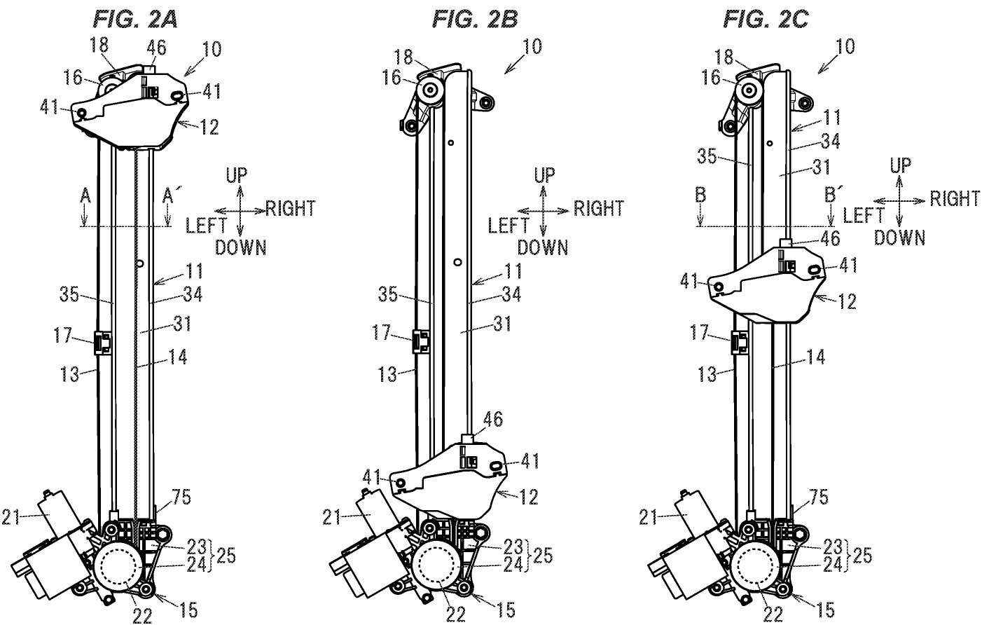

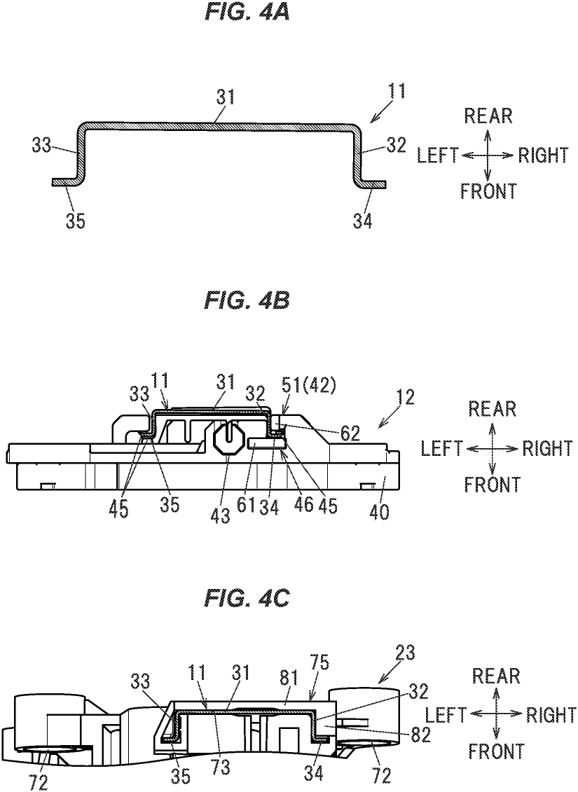

As shown in FIGS. 2 and 4A, the guide rail 11 integrally has a bottom plate portion 31 extending in the ascending/descending direction, a right-side plate portion 32 and a left-side plate portion 33 that rise toward the front from both ends in the width direction perpendicular to the ascending/descending direction and extend in the ascending/descending direction, a right flange portion 34 protruding to the right from a front end of the right-side plate portion 32 and extending in the ascending/descending direction, and a left flange portion 35 protruding to the left from an end of the left-side plate portion 33 and extending in the ascending/descending direction. The right flange portion 34 and the left flange portion 35 are formed substantially parallel to the bottom plate portion 31. In other words, the right-side plate portion 32 rises from the right flange portion 34 toward the rear and the left-side plate portion 33 rises from the left flange portion 35 toward the rear. The guide rail 11 slidably supports the carrier plate 12 at the right-side plate portion 32. In the present embodiment, the bottom plate portion 31 is the flat plate portion guided by a first fitting guide wall 81 and the right flange portion 34 is the flat plate portion guided by a first insertion guide wall 61. The right-side plate portion 32 is the side plate portion guided by a second insertion guide wall 62 and a second fitting guide wall 82.

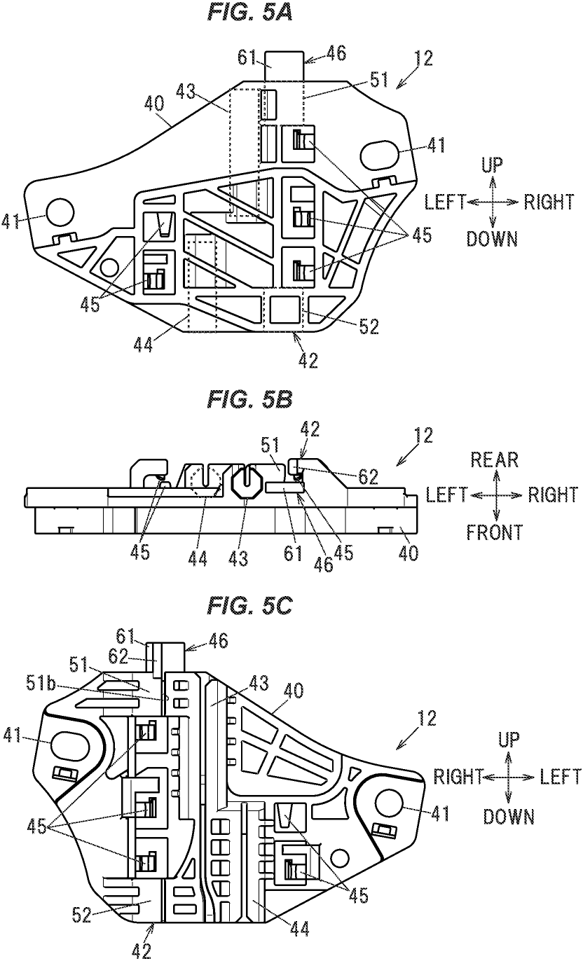

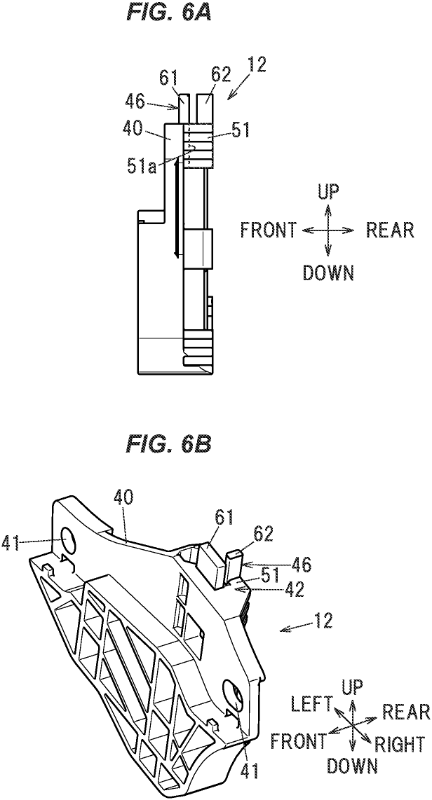

Next, the carrier plate 12 will be described in reference to FIGS. 4 to 6. As shown in FIG. 4, the carrier plate 12 is composed of a member formed of a resin (e.g., a polyacetal resin) and has a plate-shaped main body 40, two attachment holes 41, 41 formed at right and left ends of the main body 40 for attachment of the window glass 3, a rail attachment portion 42 formed on the rear surface side (in the middle and the far side of FIG. 5A) of the main body 40 on the slightly right side of the center, a descending-side wire attachment portion 43 arranged on the left of the rail attachment portion 42, an ascending-side wire attachment portion 44 arranged on the left of the descending-side wire attachment portion 43, and plural sliding fins 45 in press contact with the right flange portion 34 and the left flange portion 35 of the guide rail 11. The carrier plate 12 also has an insertion guide portion 46 formed on the upper side of the rail attachment portion 42.

The two attachment holes 41, 41 are for attachment of two glass holders (not shown) that are fixed to the window glass 3. The two glass holders fixed to the window glass 3 are attached respectively to the attachment holes 41, 41, and the window glass 3 is thereby attached to the carrier plate 12 through the two glass holders.

One end of the descending-side wire 14 is attached to the descending-side wire attachment portion 43. One end of the ascending-side wire 13 is attached to the ascending-side wire attachment portion 44. That is, the carrier plate 12 is configured to be pulled downward in the ascending/descending direction by the descending-side wire 14 through the descending-side wire attachment portion 43 and to be pulled upward in the ascending/descending direction by the ascending-side wire 13 through the ascending-side wire attachment portion 44.

The rail attachment portion 42 has an upper-end sliding portion 51 which is formed at an upper end of the main body 40 and slides against the right-side plate portion 32 of the guide rail 11, and a lower-end sliding portion 52 which is formed at a lower end of the main body 40 and slides against the right-side plate portion 32 of the guide rail 11. The upper-end sliding portion 51 and the lower-end sliding portion 52 each have a right sliding surface sliding against a right surface of the right-side plate portion 32 and a left sliding surface sliding against a left surface of the right-side plate portion 32, hence sliding against both the front and back surfaces of the right-side plate portion 32. As shown in FIG. 4B, the upper-end sliding portion 51 and the lower-end sliding portion 52 are formed to allow the right-side plate portion 32 and the right flange portion 34 of the guide rail 11 to be inserted thereinto, and the carrier plate 12 is slidably attached to the guide rail 11 by inserting the right-side plate portion 32 and the right flange portion 34 of the guide rail 11 into the upper-end sliding portion 51 and the lower-end sliding portion 52. The upper-end sliding portion 51 is an example of the insertion portion into which the guide rail 11 is inserted.

As shown in FIGS. 4B, 5 and 6, the insertion guide portion 46 has the plate-shaped first insertion guide wall 61 extending from a front inner surface 51a of the upper-end sliding portion 51 toward the upper side (toward the near side in an insertion direction) so as to protrude from an upper edge of the upper-end sliding portion 51, and the plate-shaped second insertion guide wall 62 extending from a right sliding surface 51b of the upper-end sliding portion 51 toward the upper side so as to protrude from the upper edge of the upper-end sliding portion 51. The front inner surface 51a of the upper-end sliding portion 51 is an inner surface facing a front surface of the right flange portion 34 of the guide rail 11 and is an example of the first inner surface of the insertion portion. The right sliding surface 51b of the upper-end sliding portion 51 is an inner surface facing the right surface of the right-side plate portion 32 of the guide rail 11 and is an example of the second inner surface of the insertion portion. The first insertion guide wall 61 is formed wider than the front inner surface 51a of the upper-end sliding portion 51 to increase rigidity.

A rear surface of the first insertion guide wall 61 is formed continuously with the front inner surface 51a of the upper-end sliding portion 51 without steps and serves as a guide surface that guides the right flange portion 34 of the guide rail 11 in the front-rear direction to the inside of the upper-end sliding portion 51. Thus, by moving the guide rail 11 toward the upper-end sliding portion 51 while keeping the right flange portion 34 of the guide rail 11 in sliding contact with the rear surface of the first insertion guide wall 61, the right flange portion 34 of the guide rail 11 is guided in the front-rear direction to the inside of the upper-end sliding portion 51 and is inserted into the upper-end sliding portion 51.

Meanwhile, a left surface of the second insertion guide wall 62 is formed continuously with the right sliding surface 51b of the upper-end sliding portion 51 without steps and serves as a guide surface that guides the right-side plate portion 32 of the guide rail 11 in the left-right direction to the inside of the upper-end sliding portion 51. Thus, by moving the guide rail 11 toward the upper-end sliding portion 51 while keeping the right-side plate portion 32 of the guide rail 11 in sliding contact with the left surface of the second insertion guide wall 62, the right-side plate portion 32 of the guide rail 11 is guided in the left-right direction to the inside of the upper-end sliding portion 51 and is inserted into the upper-end sliding portion 51.

As described above, the right flange portion 34 of the guide rail 11 is guided in the front-rear direction by the first insertion guide wall 61 to the inside of the upper-end sliding portion 51, and the right-side plate portion 32 of the guide rail 11 is guided in the left-right direction by the second insertion guide wall 62 to the inside of the upper-end sliding portion 51. Thus, when inserting the right flange portion 34 and the right-side plate portion 32 of the guide rail 11 into the upper-end sliding portion 51, the guide rail 11 is naturally aligned with the upper-end sliding portion 51 in the left-right and front-rear directions by the first insertion guide wall 61 and the second insertion guide wall 62. Therefore, it is possible to easily insert the right-side plate portion 32 and the right flange portion 34 of the guide rail 11 into the upper-end sliding portion 51 without special alignment.

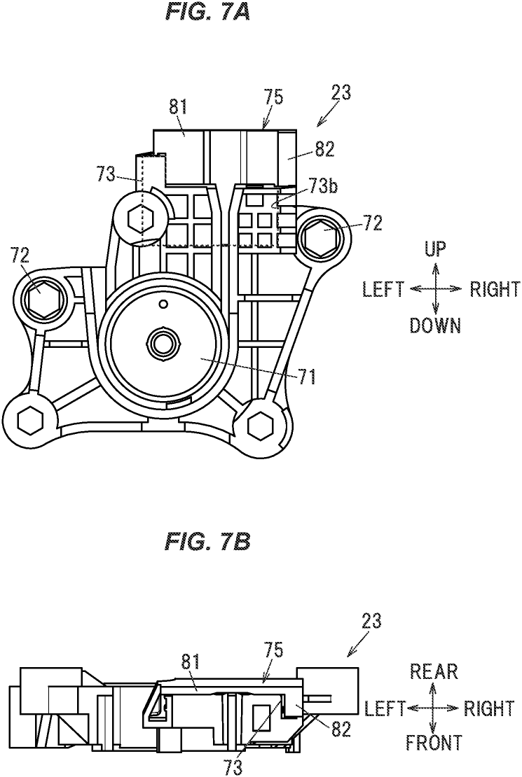

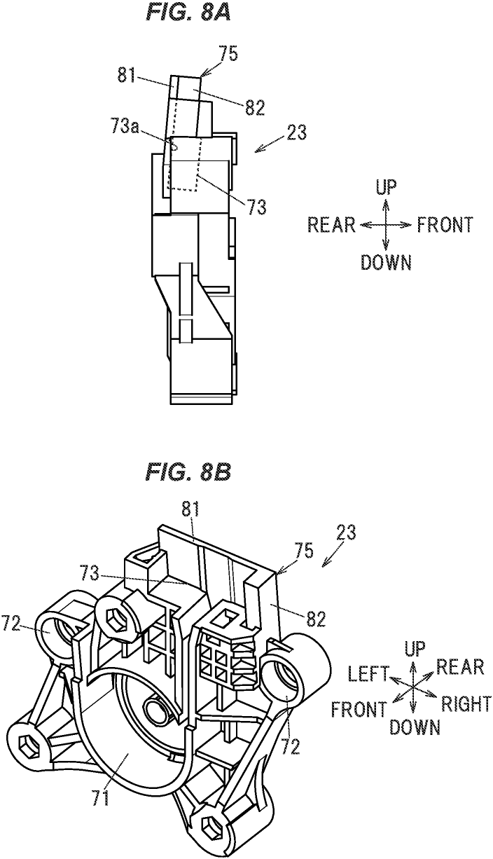

Next, the drum housing 23 will be described in reference to FIGS. 4, 7 and 8. As shown in FIGS. 7 and 8, the drum housing 23 has the drum housing portion 71 rotatably housing the rotating drum 22, two fixing holes 72, 72 to fix the drum housing 23 to an inner panel (not shown) of the vehicle door 1, a fitting hole 73 into which the lower end of the guide rail 11 is inserted and fitted, and a fitting guide portion 75 formed on the upper side of the fitting hole 73.

As shown in FIGS. 4C, 7 and 8, the fitting guide portion 75 integrally has the plate-shaped first fitting guide wall 81 extending from a rear inner surface 73a of the fitting hole 73 toward the upper side (toward the near side in the insertion direction) so as to protrude from an edge of the fitting hole 73, and the plate-shaped second fitting guide wall 82 extending from a right inner surface 73b of the fitting hole 73 toward the upper side so as to protrude from the edge of the fitting hole 73. The rear inner surface 73a of the fitting hole 73 is an inner surface facing a rear surface of the bottom plate portion 31 of the guide rail 11 and is an example of the first inner surface of the fitting hole 73. The right inner surface 73b of the fitting hole 73 is an inner surface facing the right surface of the right-side plate portion 32 of the guide rail 11 and is an example of the second inner surface of the fitting hole 73. The fitting hole 73 is formed to tilt toward the front to match the curve of the guide rail 11, and accordingly, the first fitting guide wall 81 and the second fitting guide wall 82 are also formed to tilt toward the front.

A front surface of the first fitting guide wall 81 is formed continuously with the rear inner surface 73a of the fitting hole 73 without steps and serves as a guide surface that guides the bottom plate portion 31 of the guide rail 11 in the front-rear direction to the inside of the fitting hole 73. Thus, by moving the guide rail 11 toward the fitting hole 73 while keeping the bottom plate portion 31 of the guide rail 11 in sliding contact with the front surface of the first fitting guide wall 81, the bottom plate portion 31 of the guide rail 11 is guided in the front-rear direction to the inside of the fitting hole 73 and is inserted into the fitting hole 73.

Meanwhile, a left surface of the second fitting guide wall 82 is formed continuously with the right inner surface 73b of the fitting hole 73 without steps and serves as a guide surface that guides the right-side plate portion 32 of the guide rail 11 in the left-right direction to the inside of the fitting hole 73. Thus, by moving the guide rail 11 toward the fitting hole 73 while keeping the right-side plate portion 32 of the guide rail 11 in sliding contact with the left surface of the second fitting guide wall 82, the right-side plate portion 32 of the guide rail 11 is guided in the left-right direction to the inside of the fitting hole 73 and is inserted into the fitting hole 73.

As described above, the bottom plate portion 31 of the guide rail 11 is guided in the front-rear direction by the first fitting guide wall 81 to the inside of the fitting hole 73, and the right-side plate portion 32 of the guide rail 11 is guided in the left-right direction by the second fitting guide wall 82 to the inside of the fitting hole 73. Thus, when inserting and fitting the guide rail 11 into the fitting hole 73, the guide rail 11 is naturally aligned with the fitting hole 73 in the left-right and front-rear directions by the first fitting guide wall 81 and the second fitting guide wall 82. Therefore, it is possible to easily insert the guide rail 11 into the fitting hole 73 without special alignment.

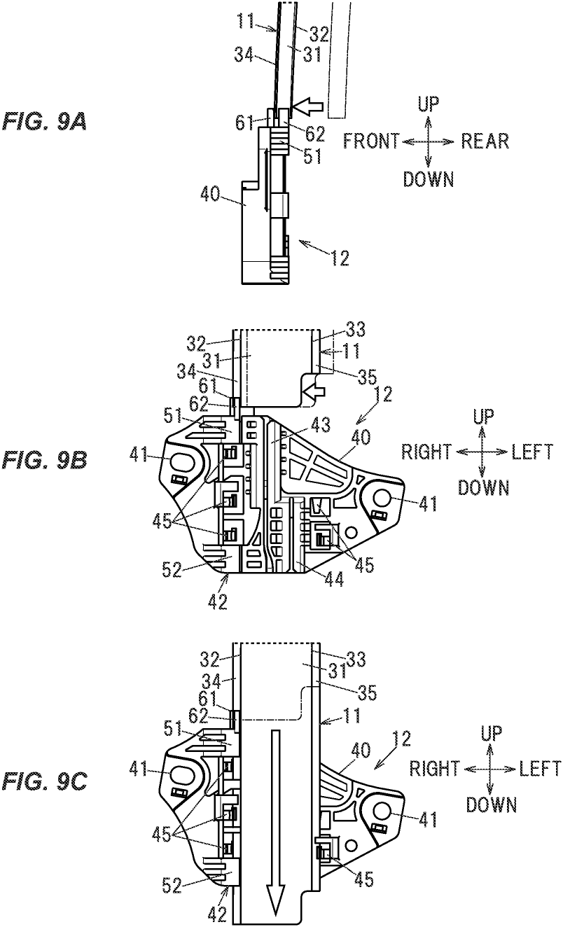

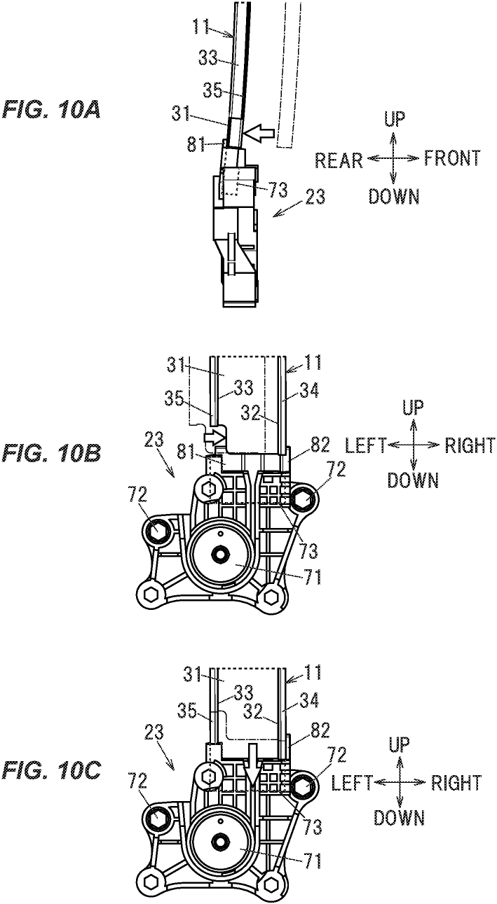

Here, a guide rail attachment operation (how to attach the guide rail 11) will be described in reference to FIGS. 9 and 10. In the present embodiment, it is configured such that after the guide rail 11 is attached to the carrier plate 12, the lower end of the guide rail 11 in the state of being attached to the carrier plate 12 is attached to the drum housing 23. Thus, the attachment operation in which the guide rail 11 is attached to the carrier plate 12 will be described as a first guide rail attachment operation, and the attachment operation in which the lower end of the guide rail 11 with the carrier plate 12 attached thereto is attached to the drum housing 23 will be described as a second guide rail attachment operation.

Firstly, the first guide rail attachment operation will be described in reference to FIG. 9. The first guide rail attachment operation is performed in a state in which the pulley bracket 18 and the pulley 16 are attached to the upper end of the guide rail 11.

In the first guide rail attachment operation, firstly, the right flange portion 34 is brought into contact with the first insertion guide wall 61 at the lower end of the guide rail 11, as shown in FIG. 9A. In particular, the front surface of the right flange portion 34 is brought into contact with the rear surface of the first insertion guide wall 61.

Then, the right-side plate portion 32 is brought into contact with the second insertion guide wall 62 at the lower end of the guide rail 11 by sliding the guide rail 11 to the right while keeping the right flange portion 34 in contact with the first insertion guide wall 61, as shown in FIG. 9B. In particular, the right surface of the right-side plate portion 32 is brought into contact with the left surface of the second insertion guide wall 62.

After bringing the right flange portion 34 and the right-side plate portion 32 respectively into contact with the first insertion guide wall 61 and the second insertion guide wall 62, the guide rail 11 is moved toward the upper-end sliding portion 51 while keeping the right flange portion 34 and the right-side plate portion 32 respectively in sliding contact with the first insertion guide wall 61 and the second insertion guide wall 62, thereby inserting the right flange portion 34 and the right-side plate portion 32 into the upper-end sliding portion 51, as shown in FIG. 9C. When the guide rail 11 is moved toward the upper-end sliding portion 51 while keeping the right flange portion 34 and the right-side plate portion 32 respectively in sliding contact with the first insertion guide wall 61 and the second insertion guide wall 62, the right flange portion 34 and the right-side plate portion 32 are guided by the first insertion guide wall 61 and the second insertion guide wall 62 to the inside of the upper-end sliding portion 51 and are inserted into the upper-end sliding portion 51. After that, the guide rail 11 is inserted until the lower end of the guide rail 11 passes beyond the lower-end sliding portion 52, and the guide rail 11 is thereby attached to the carrier plate 12.

Next, the second guide rail attachment operation will be described in reference to FIG. 10. The second guide rail attachment operation is performed after the first guide rail attachment operation as described above and is performed in a state in which the guide rail 11 is attached to the carrier plate 12.

In the second guide rail attachment operation, the bottom plate portion 31 is brought into contact with the first fitting guide wall 81 at the lower end of the guide rail 11, as shown in FIG. 10A. In particular, the rear surface of the bottom plate portion 31 is brought into contact with the front surface of the first fitting guide wall 81.

Then, the right-side plate portion 32 is brought into contact with the second fitting guide wall 82 at the lower end of the guide rail 11 by sliding the guide rail 11 to the right while keeping the bottom plate portion 31 in contact with the first fitting guide wall 81, as shown in FIG. 10B. In particular, the right surface of the right-side plate portion 32 is brought into contact with the left surface of the second fitting guide wall 82.

After bringing the bottom plate portion 31 and the right-side plate portion 32 respectively into contact with the first fitting guide wall 81 and the second fitting guide wall 82, the guide rail 11 is moved toward the fitting hole 73 while keeping the bottom plate portion 31 and the right-side plate portion 32 respectively in sliding contact with the first fitting guide wall 81 and the second fitting guide wall 82, thereby inserting the lower end of the guide rail 11 into the fitting hole 73, as shown in FIG. 10C. When the guide rail 11 is moved toward the fitting hole 73 while keeping the bottom plate portion 31 and the right-side plate portion 32 respectively in sliding contact with the first fitting guide wall 81 and the second fitting guide wall 82, the bottom plate portion 31 and the right-side plate portion 32 are guided by the first fitting guide wall 81 and the second fitting guide wall 82 to the inside of the fitting hole 73 and the lower end of the guide rail 11 is inserted into the fitting hole 73. As a result, the lower end of the guide rail 11 is fitted to the fitting hole 73 and the guide rail 11 is attached to the drum housing 23.

### Functions and Effects of the Embodiment

As described above, in the configuration of the embodiment, since the first fitting guide wall 81 and the second fitting guide wall 82 are provided on the drum housing 23, the guide rail 11 is naturally aligned with the fitting hole 73 in the left-right and front-rear directions by the first fitting guide wall 81 and the second fitting guide wall 82 at the time of inserting and fitting the guide rail 11 to the fitting hole 73. Therefore, it is possible to easily insert the guide rail 11 into the fitting hole 73 without special alignment. In other words, alignment of the guide rail 11 in the left-right and front-rear directions during insertion can be achieved simply by bringing the bottom plate portion 31 and the right-side plate portion 32 of the guide rail 11 into contact with the first fitting guide wall 81 and the second fitting guide wall 82. This can improve the attachment workability of the guide rail 11. This is also effective from the viewpoint of automating the second guide rail attachment operation.

In addition, in the configuration of the embodiment, since the first fitting guide wall 81 and the second fitting guide wall 82 are provided at the edge of the fitting hole 73, the first fitting guide wall 81 and the second fitting guide wall 82 act as reinforcement ribs, which can improve rigidity of the fitting hole 73.

For example, in the window regulator 10 of this type, a force causing the window glass 3 to tilt in the vehicle front-rear direction acts during the ascending/descending operation of the window glass 3 (particularly at the beginning of ascending or descending) and this force may cause the guide rail 11 to curve in the left-right direction. If the guide rail 11 is curved in the left-right direction, it causes a problem that the ascending/descending performance of the window glass 3 decreases and it is not possible to smoothly raise/lower the window glass 3.

In contrast, in the embodiment described above, since the rigidity of the walls forming the fitting hole 73 is improved by the first fitting guide wall 81 and the second fitting guide wall 82, curving of the guide rail 11 in the left-right direction can be suppressed by the fitting hole 73 and the decrease in the ascending/descending performance of the window glass 3 can be prevented.

In addition, in the configuration of the embodiment, since the first insertion guide wall 61 and the second insertion guide wall 62 are provided on the carrier plate 12, the guide rail 11 is naturally aligned with the upper-end sliding portion 51 in the left-right and front-rear directions by the first insertion guide wall 61 and the second insertion guide wall 62 at the time of inserting the guide rail 11 into the upper-end sliding portion 51. Therefore, it is possible to easily insert the right-side plate portion 32 and the right flange portion 34 of the guide rail 11 into the upper-end sliding portion 51 without special alignment. In other words, alignment of the guide rail 11 in the left-right and front-rear directions during insertion can be achieved simply by bringing the right-side plate portion 32 and the right flange portion 34 of the guide rail 11 into contact with the first insertion guide wall 61 and the second insertion guide wall 62. This can improve the attachment workability of the guide rail 11. This is also effective from the viewpoint of automating the first guide rail attachment operation.

In addition, in the configuration of the embodiment, since the first insertion guide wall 61 and the second insertion guide wall 62 are provided at the edge of the upper-end sliding portion 51, the first insertion guide wall 61 and the second insertion guide wall 62 act as reinforcement ribs, which can improve rigidity of the upper-end sliding portion 51. For example, in the window regulator 10 of this type, a force causing the window glass 3 to tilt in the vehicle front-rear direction acts during the ascending/descending operation of the window glass 3 (particularly at the beginning of ascending or descending) and this force may apply a large load to the upper-end sliding portion 51 and may damage the upper-end sliding portion 51.

In contrast, in the embodiment described above, since the rigidity of the walls forming the upper-end sliding portion 51 is improved by the first insertion guide wall 61 and the second insertion guide wall 62, it is possible to prevent or suppress damage on the upper-end sliding portion 51 due to the tilt of the window glass 3.

### Other Embodiments

Although the embodiment of the invention has been described, the invention according to claims is not to be limited to the embodiment. Further, please note that not all combinations of the features described in the embodiment are necessary to solve the problem of the invention. The invention can be appropriately modified and implemented without departing from the gist thereof.

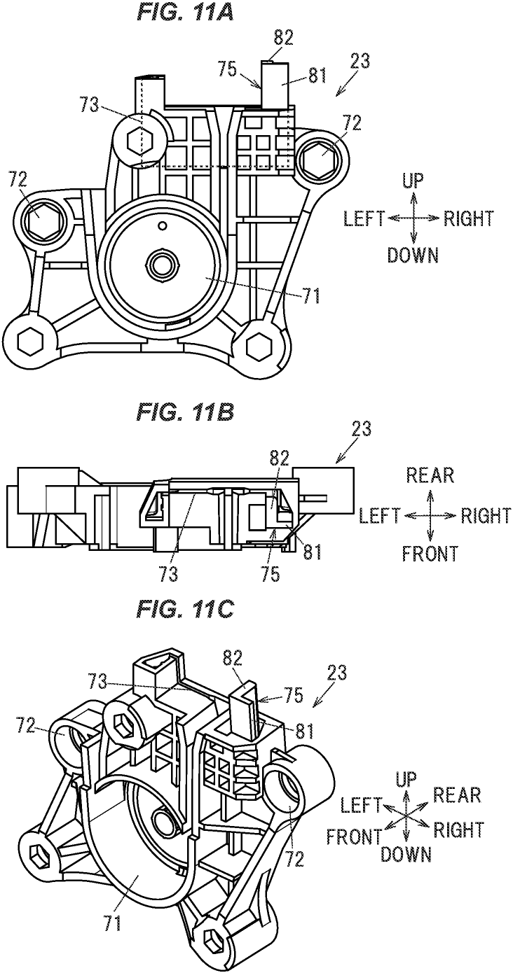

For example, although the configuration of the embodiment described above is such that the first fitting guide wall 81 formed so as to extend from the inner surface of the fitting hole 73 facing the rear surface of the bottom plate portion 31 guides the bottom plate portion 31 and the second fitting guide wall 82 formed so as to extend from the inner surface of the fitting hole 73 facing the right surface of the right-side plate portion 32 guides the right-side plate portion 32, it is not limited thereto as long as the configuration is such that the first fitting guide wall 81 formed so as to extend from the inner surface of the fitting hole 73 facing the flat plate portion (the bottom plate portion 31, the right flange portion 34 or the left flange portion 35) of the guide rail 11 guides the flat plate portion and the second fitting guide wall 82 formed so as to extend from the inner surface of the fitting hole 73 facing the side plate portion (the right-side plate portion 32 or the left-side plate portion 33) of the guide rail 11 guides the side plate portion. For example, the configuration may be such that the first fitting guide wall 81 formed so as to extend from the inner surface of the fitting hole 73 facing the front surface of the right flange portion 34 guides the right flange portion 34 of the guide rail 11, and the second fitting guide wall 82 formed so as to extend from the inner surface of the fitting hole 73 facing the left surface of the right-side plate portion 32 guides the right-side plate portion 32, as shown in FIG. 11.

In addition, although the configuration of the embodiment described above is such that the first insertion guide wall 61 formed so as to extend from the inner surface of the upper-end sliding portion 51 facing the front surface of the right flange portion 34 guides the right flange portion 34 and the second insertion guide wall 62 formed so as to extend from the inner surface of the upper-end sliding portion 51 facing the right surface of the right-side plate portion 32 guides the right-side plate portion 32, it is not limited thereto as long as the configuration is such that the first insertion guide wall 61 formed so as to extend from the inner surface of the upper-end sliding portion 51 facing the flat plate portion (the bottom plate portion 31, the right flange portion 34 or the left flange portion 35) of the guide rail 11 guides the flat plate portion and the second insertion guide wall 62 formed so as to extend from the inner surface of the upper-end sliding portion 51 facing the side plate portion (the right-side plate portion 32 or the left-side plate portion 33) of the guide rail 11 guides the side plate portion. For example, the configuration may be such that the first insertion guide wall 61 formed so as to extend from the inner surface of the upper-end sliding portion 51 facing the rear surface of the right flange portion 34 guides the right flange portion 34 of the guide rail 11, and the second insertion guide wall 62 formed so as to extend from the inner surface of the upper-end sliding portion 51 facing the left surface of the right-side plate portion 32 guides the right-side plate portion 32.

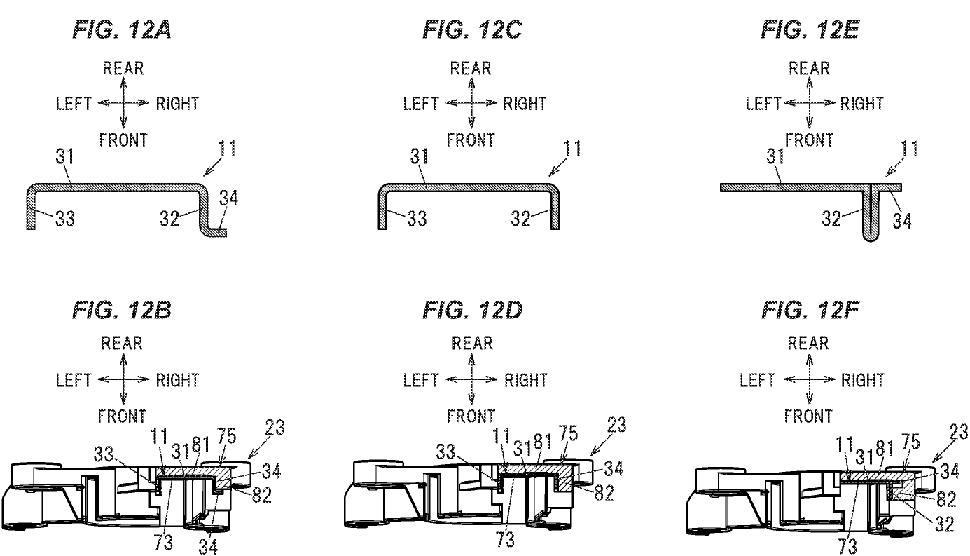

In addition, although the configuration of the embodiment described above is such that the guide rail 11 has the bottom plate portion 31, the right-side plate portion 32, the left-side plate portion 33, the right flange portion 34 and the left flange portion 35, it is not limited thereto. For example, the guide rail 11 may be configured to have the bottom plate portion 31, the right-side plate portion 32, the left-side plate portion 33 and the right flange portion 34 and not have the left flange portion 35, as shown in FIGS. 12A and 12B. Alternatively, the guide rail 11 may be configured to have the bottom plate portion 31, the right-side plate portion 32 and the left-side plate portion 33 and not have the right flange portion 34 and the left flange portion 35, as shown in FIGS. 12C and 12D. Alternatively, the right-side plate portion 32 of the guide rail 11 may have a shape that rises from the bottom plate portion 31 toward the front and then turns toward the rear, as shown in FIGS. 12E and 12F.

### REFERENCE SIGNS LIST

3 WINDOW GLASS
10 WINDOW REGULATOR
11 GUIDE RAIL
12 CARRIER PLATE
13 ASCENDING-SIDE WIRE
14 DESCENDING-SIDE WIRE
22 ROTATING DRUM
23 DRUM HOUSING
31 BOTTOM PLATE PORTION
32 RIGHT-SIDE PLATE PORTION
34 RIGHT FLANGE PORTION
51 UPPER-END SLIDING PORTION
51a FRONT INNER SURFACE
51b RIGHT SLIDING SURFACE
61 FIRST INSERTION GUIDE WALL
62 SECOND INSERTION GUIDE WALL
73 FITTING HOLE
73a REAR INNER SURFACE
73b RIGHT INNER SURFACE
81 FIRST FITTING GUIDE WALL
82 SECOND FITTING GUIDE WALL

1. A window regulator, comprising:
a guide rail provided along an ascending/descending direction of a window glass of a vehicle;
a carrier plate that supports the window glass and is slidably attached to the guide rail;
a wire to pull the carrier plate;
a rotating drum to take up and feed out the wire by rotating; and
a drum housing being provided at an end of the guide rail and housing the rotating drum,
wherein the guide rail comprises a flat plate portion extending in the ascending/descending direction, and a side plate portion rising from the flat plate portion, and
wherein the drum housing comprises a fitting hole into which the end of the guide rail is inserted and fitted, a first fitting guide wall extending from a first inner surface of the fitting hole toward the near side in an insertion direction so as to protrude from an edge of the fitting hole and guiding the flat plate portion to the fitting hole, and a second fitting guide wall extending from a second inner surface of fitting hole toward the near side in the insertion direction so as to protrude from the edge of the fitting hole and guiding the side plate portion to the fitting hole.

2. A window regulator, comprising:
a guide rail provided along an ascending/descending direction of a window glass of a vehicle;
a carrier plate that supports the window glass and is slidably attached to the guide rail;
a wire to pull the carrier plate; and
a rotating drum to take up and feed out the wire by rotating; and
wherein the guide rail comprises a flat plate portion extending in the ascending/descending direction, and a side plate portion rising from the flat plate portion, and
wherein the carrier plate comprises an insertion portion into which the guide rail is inserted, a first insertion guide wall extending from a first inner surface of the insertion portion toward the near side in an insertion direction so as to protrude from an edge of the insertion portion on the near side in the insertion direction and guiding the flat plate portion to the insertion portion, and a second insertion guide wall extending from a second inner surface of the insertion portion toward the near side in the insertion direction so as to protrude from the edge of the insertion portion on the near side in the insertion direction and guiding the side plate portion to the insertion portion.

3. A guide rail attaching method for attaching the guide rail to the drum housing in the window regulator according to claim 1, the method comprising:
after bringing the flat plate portion and the side plate portion respectively into contact with the first fitting guide wall and the second fitting guide wall, moving the guide rail toward the fitting hole while keeping the flat plate portion and the side plate portion respectively in sliding contact with the first fitting guide wall and the second fitting guide wall, thereby inserting the guide rail into the fitting hole.

4. A guide rail attaching method for attaching the guide rail to the carrier plate in the window regulator according to claim 2, the method comprising:
after bringing the flat plate portion and the side plate portion respectively into contact with the first insertion guide wall and the second insertion guide wall, moving the guide rail toward the insertion portion while keeping the flat plate portion and the side plate portion respectively in sliding contact with the first insertion guide wall and the second insertion guide wall, thereby inserting the guide rail into the insertion portion.
